(19) United States
(12) Patent Application Publication
(10) Pub. No.: US 2014/0308914 A1
(43) Pub. Date: Oct. 16, 2014

(54) MOBILE DEVICE, STORAGE MEDIUM AND METHOD FOR NOTIFYING URGENT EVENTS

(71) Applicant: HON HAI PRECISION INDUSTRY CO., LTD., New Taipei (TW)

(72) Inventors: HOU-HSIEN LEE, New Taipei (TW); CHANG-JUNG LEE, New Taipei (TW); CHIH-PING LO, New Taipei (TW)

(73) Assignee: HON HAI PRECISION INDUSTRY CO., LTD., New Taipei (TW)

(21) Appl. No.: 14/252,897

(22) Filed: Apr. 15, 2014

(30) Foreign Application Priority Data
Apr. 16, 2013 (TW) 102113536

(51) Int. Cl. H04W 4/22; H04W 8/24

(52) U.S. Cl. CPC H04W 4/22; H04W 8/24
USPC 455/404.1

(57) ABSTRACT

A computer-aided method executed on a mobile device is disclosed. The method allows a user to store profile data of an web camera into a memory of the mobile device, and to set profile data of one or more receiver devices, and to transmit the profile data of the web camera and the notice to the receiver device when an urgent event occurring in a monitored area where the web camera is located.

### FIELD

Embodiments of the present disclosure generally relate to a system and method for monitoring predetermined locations and particularly to systems and methods for monitoring urgent events and notifying such urgent events to one or more related persons.

### BACKGROUND

Web cameras are used for monitoring predetermined locations, for example home, office, warehouse or banks The video captured by a web camera can be timely observed by an appointed person. If an urgent event occurs in the monitored location, for example fire, or hijacking, a victim can dial an urgent call to an emergency call center for help. The emergency call center can include 911 for hijacking or fire. However, when such urgent event occurs, the victim usually becomes too nervous to tell accurate information to the emergency call center. Therefore, the emergency center cannot timely obtain the necessary information for providing assistance.

### BRIEF DESCRIPTION OF THE DRAWINGS

FIG. 1 is a block diagram of one embodiment of a system for notifying urgent events.

FIG. 2 is a flowchart of one embodiment of a method for notification of urgent events.

FIG. 3, FIG. 4 and FIG. 5 are schematic interfaces of example embodiments of a method for notification of urgent events.

### DETAILED DESCRIPTION

All of the processes described below may be embodied in, and fully automated via, functional code modules executed by one or more general purpose electronic devices or processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

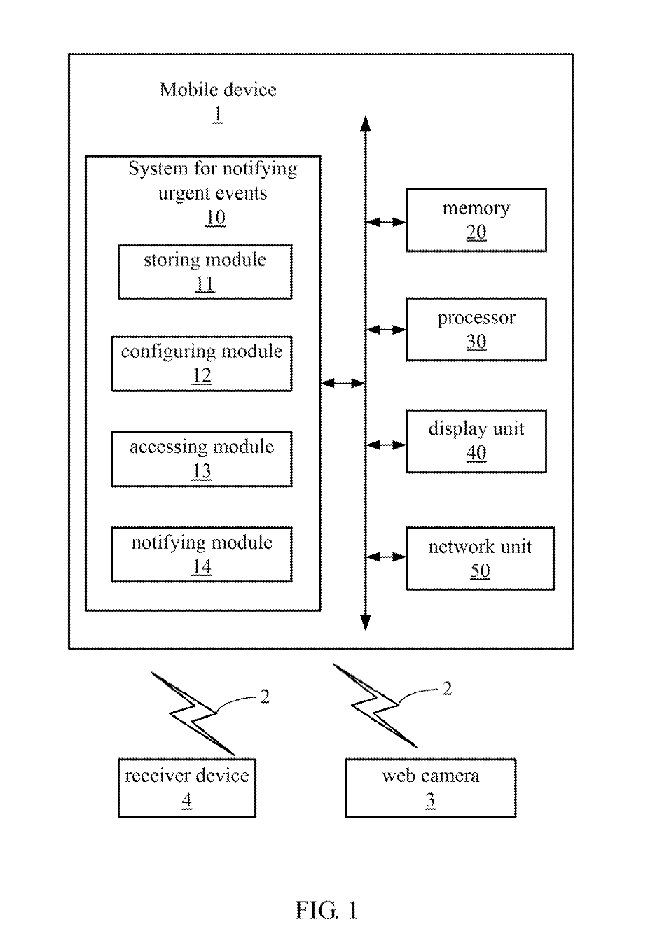

FIG. 1 is a block diagram of one embodiment of a system for notifying urgent events. System 10 can be used on a mobile device 1, for example a mobile phone, or a personal digital assistant. The mobile device 1 can include a memory 20, a processor 30, a display unit 40, and a network unit 50. The mobile device 1 can be connected to a network 2 via the network unit 50. The network 2 can be the Internet, a wireless mobile communication network or any other public accessible networks. A web camera 3 and one or more receiver devices 4 can be connected to the network 2. The receiver device 4 can be a device with a display module for displaying video captured by the web camera 3. For example, the receiver device 4 can be a computer, or a mobile phone monitored by an emergency call center, the police, family members or other contacts.

The web camera 3 can be located at a predetermined location for capturing video around the predetermined location. Web camera 3 can have a profile. The profile can contain data of the web camera 3, for example, IP address, physical location, address of the physical location, and one or more authorized user names and corresponding passwords which are used for watching video of web camera 3. The profile data is stored in the memory 20 of mobile device 1. A user, such as the owner of the mobile device 1, can login to the system 10 by inputting an authorized user name and a corresponding password to watch the video captured by the web camera 3. Once an urgent event occurs, the owner of the mobile device 1 can login to the system 10 to notify the one or more receiver devices 4 of the emergency event by transmitting a predetermined notice to the one or more receiver devices 4. The profile data of the web camera 3 can be transmitted sequentially to the one or more receiver devices 4. When the one or more receiver devices 4 receive the notice and the profile data of the web camera 3, the persons who monitor the one or more receiver devices 4 can login to the system 10 to timely watch the video captured by the web camera 3, so as to collect enough information to provide assistance.

Referring to FIG. 1, the system 10 can include computerized instructions in the form of one or more programs that are executed by the processor 30 and stored in the memory 20. In one embodiment, the system 10 can include one or more modules, for example, a storing module 11, a configuring module 12, an accessing module 13, and a notifying module 14. A “module,” as used herein, refers to logic embodied in hardware or firmware, or to a collection of software instructions, written in a programming language, such as, JAVA, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

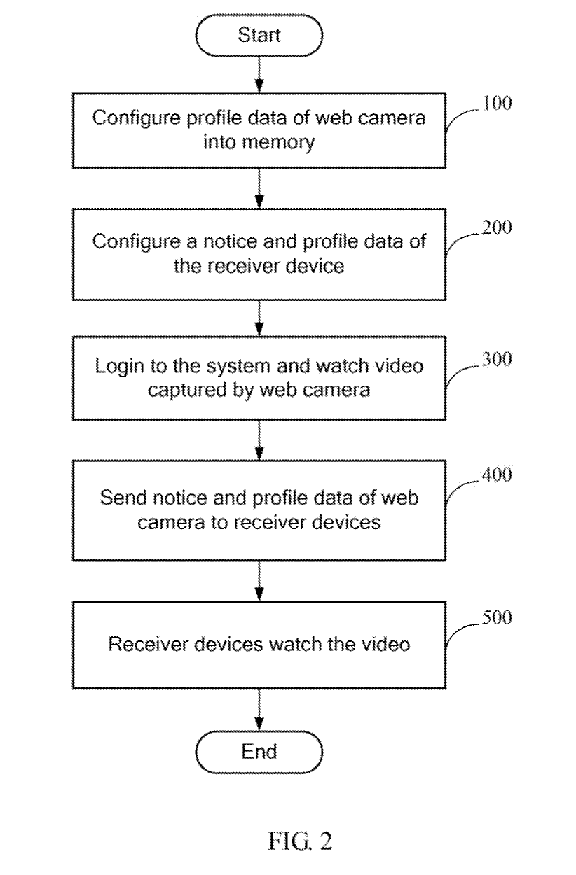

FIG. 2 is a flowchart of one embodiment of a method for notifying urgent events to related persons using the system. Depending on the embodiment, additional steps may be added, others removed, and the ordering of the steps may be changed.

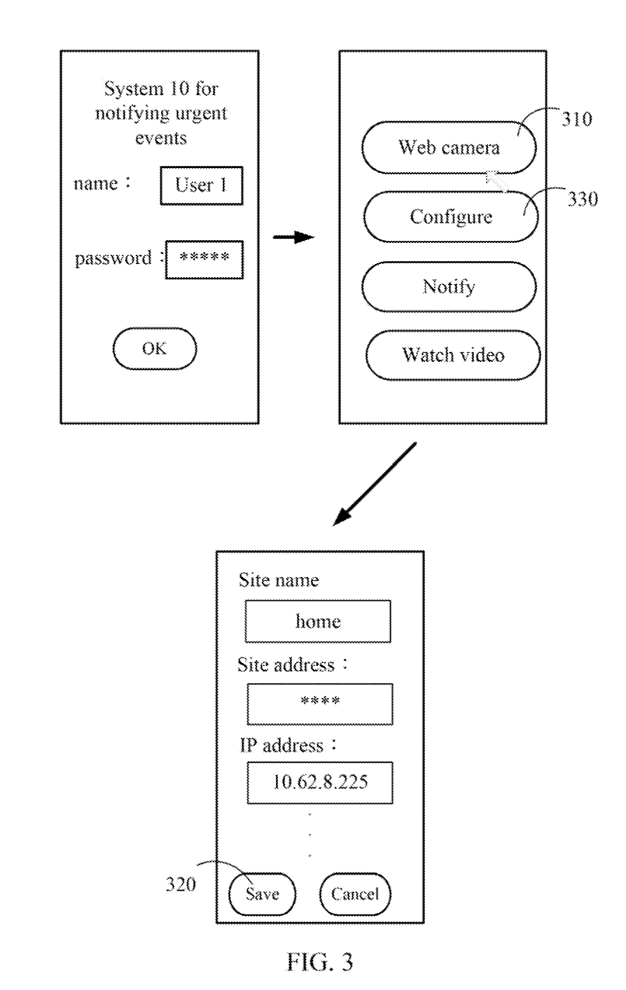

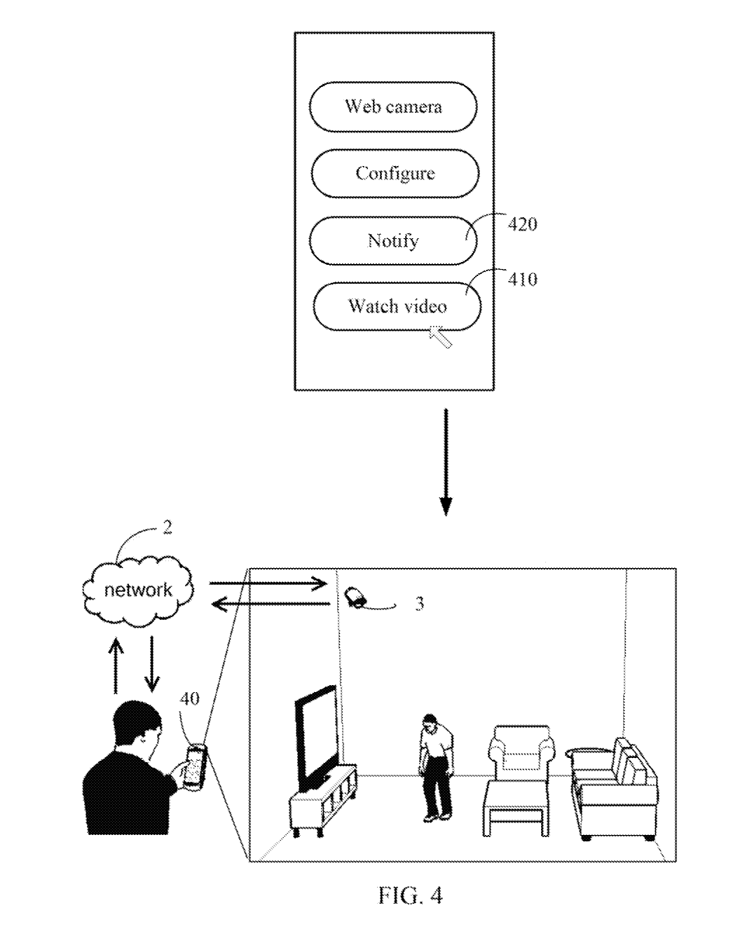

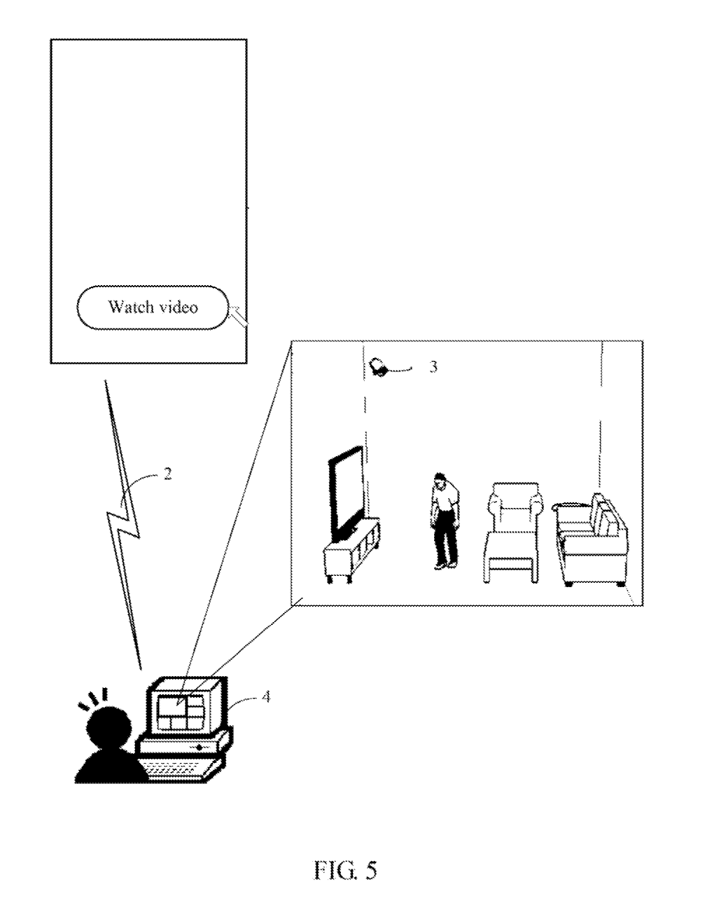

At block 100, the storing module configures and stores the profile data of the web camera to the memory of mobile device. In an embodiment, the profile data of the web camera can include physical location of the web camera, address of the physical location, the name of the web camera, IP address of the web camera, and one or more authorized user names and corresponding passwords. Each authorized user name and a corresponding password can be used for watching the video captured by the web camera. Referring to FIG. 3, a user can login to the system by entering an authorized name and a corresponding password. In an embodiment, the user can save the authorized user name and the corresponding password into the memory so that the user can quickly login to the system without manually entering the user name and the password. The user can click the “Web camera” button to edit the profile data of the web camera. The profile data of the web camera is stored into the memory when the “save” button is pressed.

At block 200, the configuring module can be used for configuration of the notifying module. Referring to FIG. 3, the user can press the “configure” button to activate the configuring module. In one embodiment, the configuring module can configure the notifying module. Configuration data can include a notice representing an urgent event occurring and profile data of the receiver device. The configuration data set by the configuring module can be stored into the memory. The notice can be a text message, for example, “danger! Please help me!” In other embodiments, the notice can be a voice message or another form of alarm. The profile data of the receiver device can be configuration data for a phone or computer. In one embodiment, the profile data of the receiver device can include IP address of a computer monitored by the police, a cell phone number of a family member or a phone number of a close friend. When the profile data of the receiver devices is stored in the memory, the user can set a priority order for each receiver device. When an urgent event occurs, the mobile device can transmit a notice to one or more receiver devices according to the predetermined priority order.

At block 300, the accessing module can be used to watch the video of web camera. The video can be watched by a user pressing the “Watch video” button. The user can be connected to the web camera via the network to view the video captured by the web camera, as shown in FIG. 4. Referring to FIG. 4, the video can be displayed on the display unit of the mobile device.

At block 400, the notifying module can transmit a notification signal to an emergency call center. In one embodiment, pressing the “notify emergency” button can create a notifying action. The notifying action includes transmitting a predetermined notice representing danger occurring and the profile data of the web camera to one or more receiver devices. When an urgent event occurs, such as fire or hijack, the user can press the “notify” button to activate the notifying action. In other embodiments, the “notify” button can be displayed in any striking position on the display unit of the mobile device so that the user can quickly find the “notify” button.

At block 500, a receiver device can collect information in regards to an emergency situation. Referring to FIG. 5, the one or more receiver devices can be connected to the web camera via the network and view the video captured by the web camera by entering the authorized user name and the corresponding password. Referring to FIG. 5, the one or more receiver devices can watch the video to know what happened at the predetermined location.

It should be emphasized that the above-described embodiments of the present disclosure, particularly, any embodiments, are merely possible examples of implementations, set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure is protected by the following claims.

What is claimed is:

1. A computer-implemented method comprising:
configuring, at a mobile device, profile data of a web camera located at a predetermined location;
configuring, at the mobile device, a notice representing an urgent event occurring;
configuring, at the mobile device, profile data of one or more receiver devices, the profile data including an authorized user name and a corresponding password;
storing, at the mobile device, the profile data of the one or more receiver devices, the webcam, and the notice into the memory; and
transmitting, by the mobile device, the notice and the profile data of the web camera to the one or more receiver devices in response to an emergency event.

2. The method according to claim 1, wherein the profile data of the web camera comprises a physical address of the predetermined location and IP address of the web camera.

3. The method according to claim 1, wherein the profile data of the receiver devices comprises a sending order of each receiver device, wherein the sending order ranks priority for transmission of the notice and the profile data of the web camera.

4. A mobile device, comprising:
a memory for storing instructions;
a processor for executing the instructions to performing a method, the method comprising:
configuring, at the mobile device, profile data of a web camera located at a predetermined location;
configuring, at the mobile device, a notice representing an urgent event occurring;
configuring, at the mobile device, profile data of one or more receiver devices, the profile data including an authorized user name and a corresponding password;
storing, at the mobile device, the profile data of the one or more receiver devices, the webcam, and the notice into the memory; and
transmitting, by the mobile device, the notice and the profile data of the web camera to the one or more receiver devices in response to an emergency event.

5. The mobile device according to claim 4, wherein the profile data of the web camera comprises a physical address of the predetermined location and IP address of the web camera.

6. The mobile device according to claim 4, wherein the profile data of the receiver devices comprises a sending order of each receiver device, wherein the sending order ranks priority for transmission of the notice and the profile data of the web camera.

7. The mobile device according to claim 4, wherein the mobile device further comprises a display unit for displaying the video.

8. The mobile device according to claim 4, wherein the mobile device further comprises a network unit allowing the mobile device to be connected to a public accessible network.

9. A storage medium for storing computer-implemented instructions, the instructions being executed to perform a method, the method comprising:
configuring, at a mobile device, profile data of a web camera located at a predetermined location;
configuring, at the mobile device, a notice representing an urgent event occurring;
configuring, at the mobile device, profile data of one or more receiver devices, the profile data including an authorized user name and a corresponding password;
storing, at the mobile device, the profile data of the one or more receiver devices, the webcam, and the notice into the memory; and
transmitting, by the mobile device, the notice and the profile data of the web camera to the one or more receiver devices in response to an emergency event.

10. The storage medium according to claim 9, wherein the profile data of the web camera comprises a physical address of the predetermined location and IP address of the web camera.

11. The storage medium according to claim 9, the profile data of the receiver devices comprises a sending order of each receiver device, wherein the sending order ranks priority for transmission of the notice and the profile data of the web camera.
